(19) United States
(12) Patent Application Publication
(10) Pub. No.: US 2012/0131854 A1
(43) Pub. Date: May 31, 2012

(54) Draft Blocker With Magnet

(76) Inventors: James Pettingill, Essex Junction, VT (US); Yves Syrkos, Blainville (CA)

(21) Appl. No.: 13/306,190

(22) Filed: Nov. 29, 2011

Related U.S. Application Data
(60) Provisional application No. 61/344,955, filed on Nov. 29, 2010.

(51) Int. Cl. E06B 7/18

(52) U.S. Cl. 49/478.1

(57) ABSTRACT

A draft blocker to be applied to the base of a door, comprising an elongated insulating member substantially the width of the door and a magnetic member.

### CROSS-REFERENCE TO RELATED APPLICATIONS

This application claims the benefits of U.S. provisional patent application No. 61/344,955 filed on Nov. 29, 2010, which is herein incorporated by reference.

### TECHNICAL FIELD

The present disclosure relates to a draft blocker, and more particularly to a draft blocker that is magnetically securable to a door to block the draft there under.

### BACKGROUND

Known door draft blockers often require clips that would attach onto the door with an adhesive, a clamp or mechanically with screws. However, they do not move or stay in contact with a metal or steel door.

Accordingly, there is a need for an improved draft blocker.

### SUMMARY

The present disclosure provides a draft blocker to be applied to the base of a door, comprising an elongated insulating member substantially the width of the door and a magnetic member.

The present disclosure further provides a draft blocker as above wherein the elongated insulating member is composed of a sleeve containing therein insulating material.

The present disclosure also provides a draft blocker in accordance as above wherein the magnetic member is a thin flexible magnet strip.

### BRIEF DESCRIPTION OF THE FIGURES

Embodiments of the disclosure will be described by way of examples only with reference to the accompanying drawings, in which similar references used in different figures denote similar components, wherein:

FIG. 1 is a back perspective view of a draft blocker with magnet in accordance with an illustrative embodiment of the present disclosure, shown with optional door clips;

FIGS. 2A and 2B are enlarged section views of the embodiment of FIG. 1 along axis 2-2, showing installation on a wood door with clips (FIG. 2A) and installation on a metal door with magnet (FIG. 2B);

FIGS. 3 and 4 are perspective views of the embodiment of FIG. 2A, showing installation of the clips on a wood door, and of the draft blocker on the clips, respectively; and

FIG. 5 is a perspective view of the embodiment of Fig, 2B, showing installation on a metal door with magnet.

### DETAILED DESCRIPTION

Generally stated, non-limitative illustrative embodiments of the present disclosure provide a draft blocker that is magnetically securable to a metal door (or other magnetic material) to block the draft there under. The design of the draft blocker allows it to easily work with metal doors having a threshold or exterior doors having rubber bumpers and D molds. In alternative illustrative embodiments, the draft blocker may also be secured to a wooden door (or other non-magnetic material) using optional support loops and associated door clips.

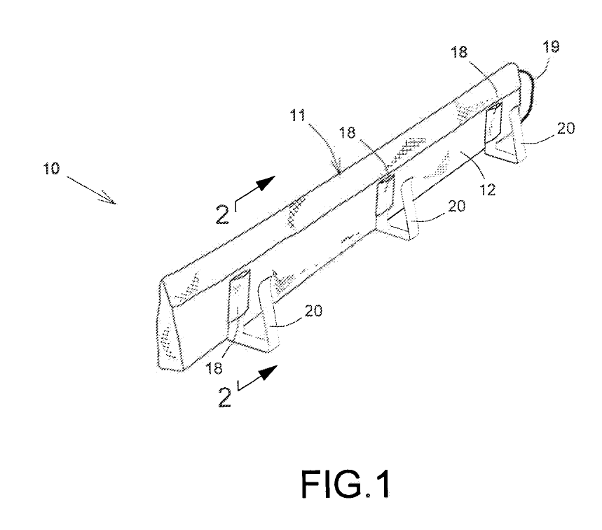

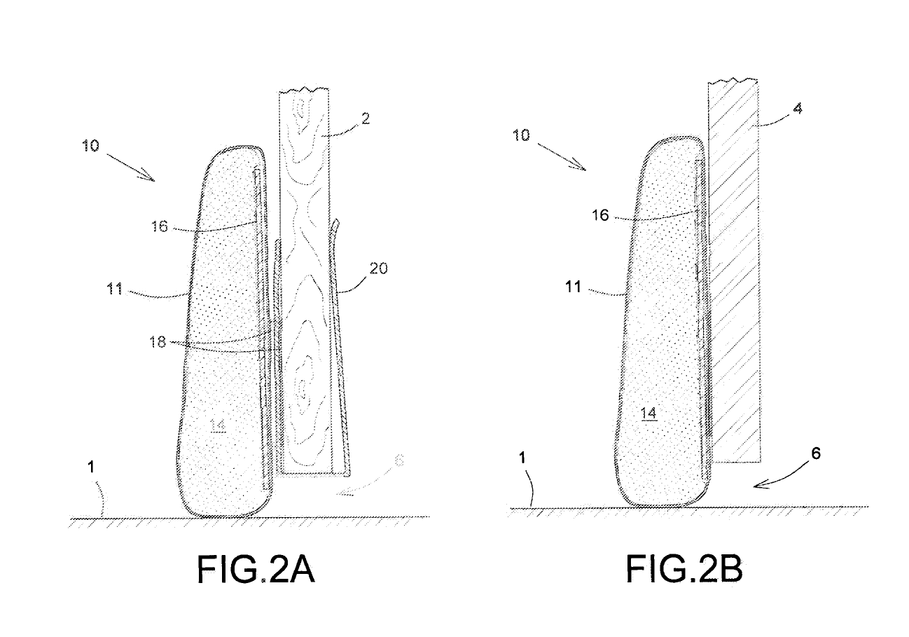

Referring to FIGS. 1, 2A and 2B, there is shown a draft blocker 10 in accordance with an illustrative embodiment of the present disclosure. The draft blocker 10 comprises an elongated insulating member 11, substantially the width of a door, composed of a sleeve 12 containing therein insulating material 14 and a magnetic member 16 (best seen in FIGS. 2A and 26). Optionally, the sleeve 12 can further be provided with support loops 18 configured to slidingly engage doors clips 20 in order to install the draft blocker 10 on a wooden door 2. It is to be understood that the draft blocker 10 may be of various sizes corresponding to different sizes of doors.

The sleeve 12 forms the outside layer of the draft blocker 10 and is made of fleece or the like in order to give the draft blocker 10 a feeling of warmth. It is to be understood, however, that in alternative embodiments other materials may be used, such as, for example, nylon or other similar materials.

Optionally, the sleeve 12 is provided with a handle 19 or other holding means to allow easy transportation or handling of the draft blocker 10.

The insulating material 14 takes the form of a thick pile of polyester or the like providing the insulating properties of the draft blocker 10. It is to be understood, however, that in alternative embodiments other insulating materials or combination of materials may be used Furthermore, insulating material 14 may also be formed of a plurality of layers of one or more materials.

The magnetic member 16 is a thin flexible magnet strip that sits in between the sleeve 12 and the insulating material 14. Optionally, the magnetic member 16 may be positioned in a pocket (not shown), or fixed using an adhesive, on an interior surface of the sleeve 12. In an alternative embodiment, the magnetic member 16 may be positioned in a pocket (not shown), or fixed using an adhesive, on an exterior surface of the sleeve 12. In a further alternative embodiment, the magnetic member 16 may be composed of a plurality of elements in the form of magnets or flexible magnet strip segments.

In the illustrative embodiment, the sleeve 12, insulating material 14 and magnetic member 16 are sown together in one package, It is to be understood, however, that the sleeve 12 may be configured so as to allow access to the insulating material 14 and magnetic member 16 therein for removal of same. In an alternative embodiment, the main body 11 may be an integral insulating material form replacing the sleeve 12 and insulating material 14, in which case the magnetic member 16 is affixed or applied to an exterior surface of the main body 11.

As may be seen in FIGS. 2A and 2B, when installed on a wooden door 2 (FIG. 2A) or a metal door 4 (FIG. 2B), the draft blocker 10 blocks the space 6 between the door 2, 4 and the floor 1, which space 6 is conductive to drafts. Furthermore, the draft blocker 10 moves with the door 2, 4, thus remaining in position as the door 2, 4 is opened and closed.

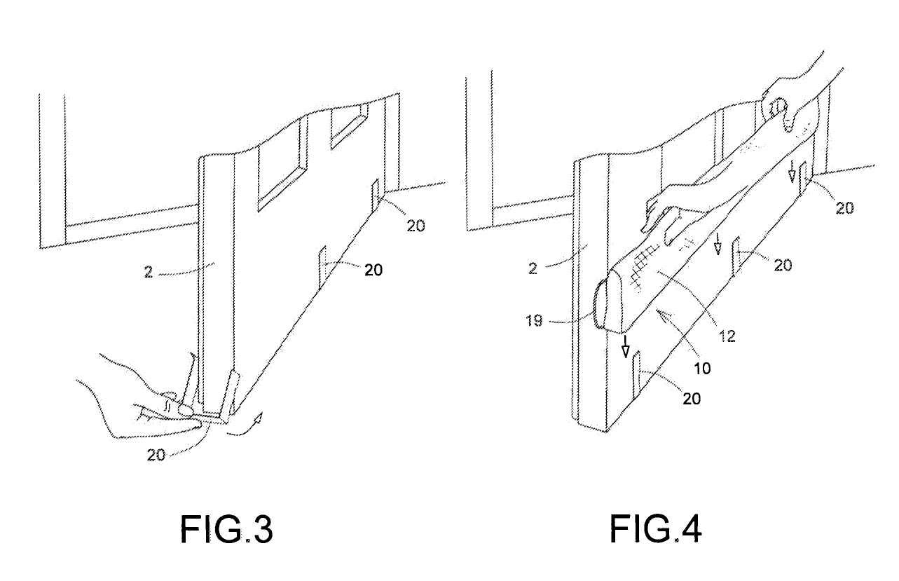

Referring now to FIGS. 3 and 4, the draft blocker 10 is installed on a wooden door 2 by first placing doors clips 20 along the base of the wooden door 2 at intervals corresponding to the positioning of the optional support loops 18 (FIG. 3). Following this, the draft blocker 10 is positioned at the base of the wooden door 2 by slidingly engaging the support loops 18 with corresponding door clips 20.

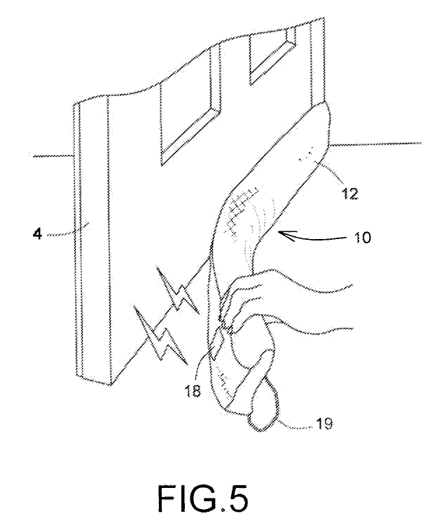

Referring to FIG. 5, the draft blocker 10 is installed on a metal door 4 by simply placing the draft blocker 10 at the base of the metal door, the magnetic properties of the magnetic member 16 securing the draft blocker 10 to the metal door 4.

In an alternative embodiment, the door clips 20 may be made, completely or partially, of a magnetic material or be provided with magnet strip inserts or portions so as to allow the securing of the draft blocker 10 to a wooden door 2 without requiring the presence of the optional support loops 18.

In a further alternative embodiment, an adhesive backed magnetic material strip or magnet strip may be secured to the base of the wooden door 2 so as to allow the securing of the draft blocker 10 without requiring the presence of the optional support loops 18 and door clips 20.

It is to be understood that in the present disclosure references to a wooden door equally apply to doors made of other non-magnetic materials and that references to a metal door equally apply to doors made of other magnetic materials.

Although the present disclosure has been described with a certain degree of particularity and by way of illustrative embodiments and examples thereof, it is to be understood that the present disclosure is not limited to the features of the embodiments described and illustrated herein, but includes all variations and modifications within the scope and spirit of the disclosure as hereinafter claimed.

What is claimed:

1. A draft blocker to be applied to the base of a door, comprising:
an elongated insulating member substantially the width of the door; and
a magnetic member.

2. A kit for preventing drafts from coming under a door, comprising a draft blocker in accordance with claim 1 and a plurality of door clips configured to be secured to the base of the door, the door clips having at least a magnetic material or magnet strip portion.

3. A kit for preventing drafts from coming under a door, comprising a draft blocker in accordance with claim 1 and an adhesive backed magnetic material strip or magnet strip configured to be secured to the base of the door.

4. A draft blocker in accordance with claim 1, wherein the elongated insulating member further includes a plurality of support loops configured to slidingly engage doors clips.

5. A kit for preventing drafts from coming under a door, comprising a draft blocker in accordance with claim 4 and a plurality of door clips configured to be secured to the base of the door and to slidingly engage the support loops.

6. A draft blocker in accordance with claim 1, wherein the magnetic member is a thin flexible magnet strip.

7. A draft blocker in accordance with claim 1, wherein the magnetic member is composed of a plurality of elements selected from the group consisting of a magnet and a flexible magnet strip segment.

8. A draft blocker in accordance with claim 1, wherein the elongated insulating member includes a handle.

9. A draft blocker in accordance with claim 1, wherein the elongated insulating member is composed of a sleeve containing therein insulating material.

10. A draft blocker in accordance with claim 9, wherein the sleeve is made of fleece.

11. A draft blocker in accordance with claim 9, wherein the insulating material is a thick pile of polyester.

12. A draft blocker in accordance with claim 9, wherein the magnetic member is positioned in a pocket on an interior surface of the sleeve.

13. A draft blocker in accordance with claim 9, wherein the magnetic member is fixed using an adhesive on an interior surface of the sleeve.

14. A draft blocker in accordance with claim 9, wherein the magnetic member is positioned in a pocket on an exterior surface of the sleeve.

15. A draft blocker in accordance with claim 9, wherein the magnetic member is fixed using an adhesive on an exterior surface of the sleeve.

16. A draft blocker in accordance with claim 9, wherein the magnetic member is a thin flexible magnet strip positioned between the insulating material and the sleeve.

17. A kit for preventing drafts from coming under a door, comprising a draft blocker in accordance with claim 16 and a plurality of door clips configured to be secured to the base of the door, the door clips having at least a magnetic material or magnet strip portion.

18. A kit for preventing drafts from coming under a door, comprising a draft blocker in accordance with claim 16 and an adhesive backed magnetic material strip or magnet strip configured to be secured to the base of the door.

19. A draft blocker in accordance with claim 16, wherein the sleeve further includes a plurality of support loops configured to slidingly engage doors clips.

20. A kit for preventing drafts from coming under a door, comprising a draft blocker in accordance with claim 19 and a plurality of door clips configured to be secured to the base of the door and to slidingly engage the support loops.
